(19) United States
(12) Patent Application Publication
(10) Pub. No.: US 2025/0007083 A1
(43) Pub. Date: Jan. 2, 2025

(54) BATTERY PACK VENT BYPRODUCT SHIELD ASSEMBLY AND THERMAL ENERGY MANAGEMENT METHOD

(71) Applicant: Ford Global Technologies, LLC, Dearborn, MI (US)

(72) Inventor: Xiaogang Zhang, Novi, MI (US)

(21) Appl. No.: 18/346,216

(22) Filed: Jul. 1, 2023

(51) Int. Cl. H01M 50/367; H01M 50/209; H01M 50/548

(52) U.S. Cl. CPC H01M 50/367; H01M 50/209; H01M 50/548

(57) ABSTRACT

A battery pack assembly includes a first battery cell stack, a second battery cell stack, and an enclosure having an interior area. The first and second battery cell stacks are housed within the interior area. A shield spans over the first and second battery cell stacks within the interior area. The shield defines a first channel with the first battery cell stack to receive vent byproducts from at least one battery cell within the first battery cell stack. The shield defines a second channel with the second battery cell stack to receive vent byproducts from at least one battery cell within the second battery cell stack.

### TECHNICAL FIELD

This disclosure relates generally to managing vented byproducts within a battery pack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. The traction battery pack assembly of an electrified vehicle can include groups of battery cells.

### SUMMARY

In some aspects, the techniques described herein relate to a battery pack assembly, including: a first battery cell stack; a second battery cell stack; an enclosure having an interior area, the first and second battery cell stacks housed within the interior area; and a shield spanning over the first and second battery cell stacks within the interior area, the shield defining a first channel with the first battery cell stack to receive vent byproducts from at least one battery cell within the first battery cell stack, the shield defining a second channel with the second battery cell stack to receive vent byproducts from at least one battery cell within the second battery cell stack.

In some aspects, the techniques described herein relate to a battery pack assembly, wherein the shield is a polymer-based material.

In some aspects, the techniques described herein relate to a battery pack assembly, wherein the shield is less than three millimeters thick.

In some aspects, the techniques described herein relate to a battery pack assembly, wherein the shield is a stamped shield.

In some aspects, the techniques described herein relate to a battery pack assembly, wherein the first battery cell stack include a plurality of first battery cell vents, a plurality of terminals on a first side of the plurality of first battery cell vents, and a plurality of terminals on an opposite, second side of the plurality of first battery cell vents, the shield contacting the first battery cell stack at a first location between the plurality of first battery cell vents and the plurality of terminals on the first side, the shield contacting the first battery cell stack at a second location between the plurality of first battery cell vents and the plurality of terminals on the second side.

In some aspects, the techniques described herein relate to a battery pack assembly, wherein the shield is raised above the plurality of first battery cell vents more than the shield is raised of the plurality of terminals.

In some aspects, the techniques described herein relate to a battery pack assembly, wherein the shield defines a third channel above the plurality of terminals on the first side, and a fourth channel above the plurality of terminals on the second side, wherein the first and second channels are larger than the third and fourth channels.

In some aspects, the techniques described herein relate to a battery pack assembly, wherein the shield is sandwiched between a cover of the enclosure and the first battery cell stack.

In some aspects, the techniques described herein relate to a battery pack assembly, wherein the first channel is open at an axial end of the first battery cell stack, wherein the second channel is open at an axial end of the second battery cell stack.

In some aspects, the techniques described herein relate to a battery pack assembly, wherein the enclosure includes a plurality of corrugations that project toward the shield.

In some aspects, the techniques described herein relate to a battery pack assembly, wherein the corrugations within the plurality of corrugations each contacts a portion of the shield providing a terminal clearance channel.

In some aspects, the techniques described herein relate to a battery pack assembly, wherein a cover of the enclosure includes the plurality of corrugations.

In some aspects, the techniques described herein relate to a battery pack assembly, wherein the corrugations within the plurality of corrugations each have a triangular cross-sectional profile.

In some aspects, the techniques described herein relate to a method of managing thermal energy within a battery pack, including: positioning a shield within an interior area of an enclosure between a wall of the enclosure and a plurality of battery cells; and using the shield to define a channel that spans over a plurality of vents of the plurality of battery cells, the channel configured to receive vent byproducts vented from the plurality of battery cells.

In some aspects, the techniques described herein relate to a method, further including stamping the shield to establish the channel.

In some aspects, the techniques described herein relate to a method, wherein the shield is a polymer-based material.

In some aspects, the techniques described herein relate to a method, wherein the plurality of battery cells include a plurality of terminals on a first side of the plurality of vents, and a plurality of terminals on an opposite, second side of the plurality of vents, the shield including contact areas that contact the plurality of battery cells at a first location between the plurality of vents and the plurality of terminals on the first side, the shield including additional contact areas that contact the plurality of battery cells at a second location between the plurality of vents and the plurality of terminals on the second side.

In some aspects, the techniques described herein relate to a method, further including stamping the shield in a first direction to provide the channels, and stamping the shield in an opposite, second direction to provide the contact areas.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an example electrified vehicle.

FIG. 2 illustrates an expanded, perspective view of a battery pack from the electrified vehicle of FIG. 1.

FIG. 3 illustrates a section side view of the battery pack of FIG. 2.

FIG. 4 illustrates a sheet of material when stamping the sheet to provide a shield for the battery pack of FIGS. 1 and 2.

### DETAILED DESCRIPTION

This disclosure details traction battery pack assemblies having a shield spanning over groups of one or more battery cells. The shield is configured to contain and direct vent byproducts that may vent from within one or more of the battery cells.

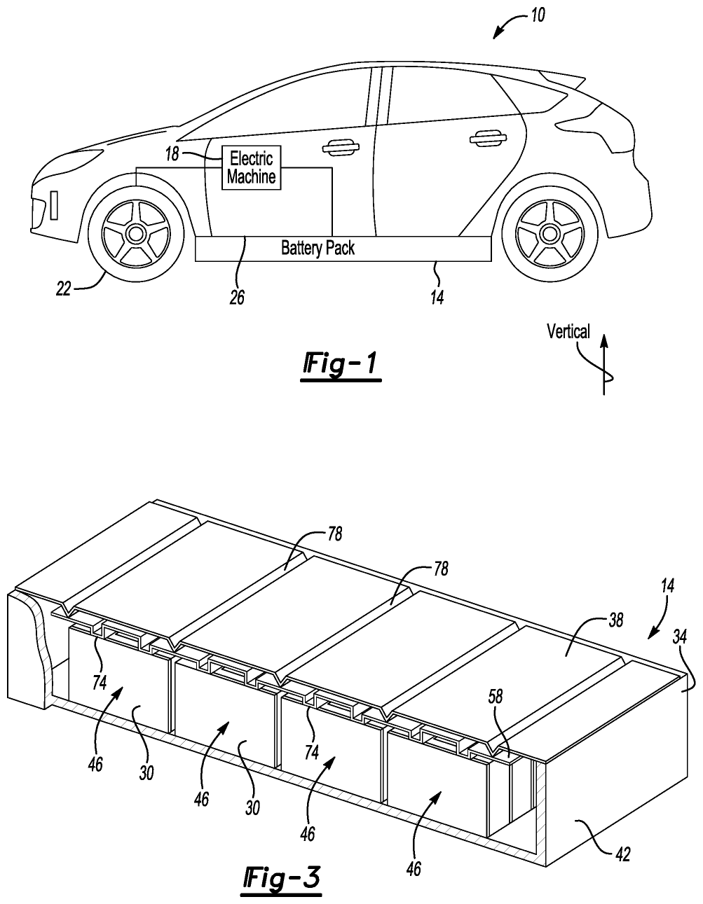

With reference to FIG. 1, an electrified vehicle 10 includes a traction battery pack assembly 14, an electric machine 18, and wheels 22. The traction battery pack assembly 14 powers an electric machine 18, which can convert electrical power to mechanical power to drive the wheels 22. The traction battery pack assembly 14 can be a relatively high-voltage battery.

The traction battery pack assembly 14 is, in the exemplary embodiment, secured to an underbody 26 of the electrified vehicle 10. The traction battery pack assembly 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

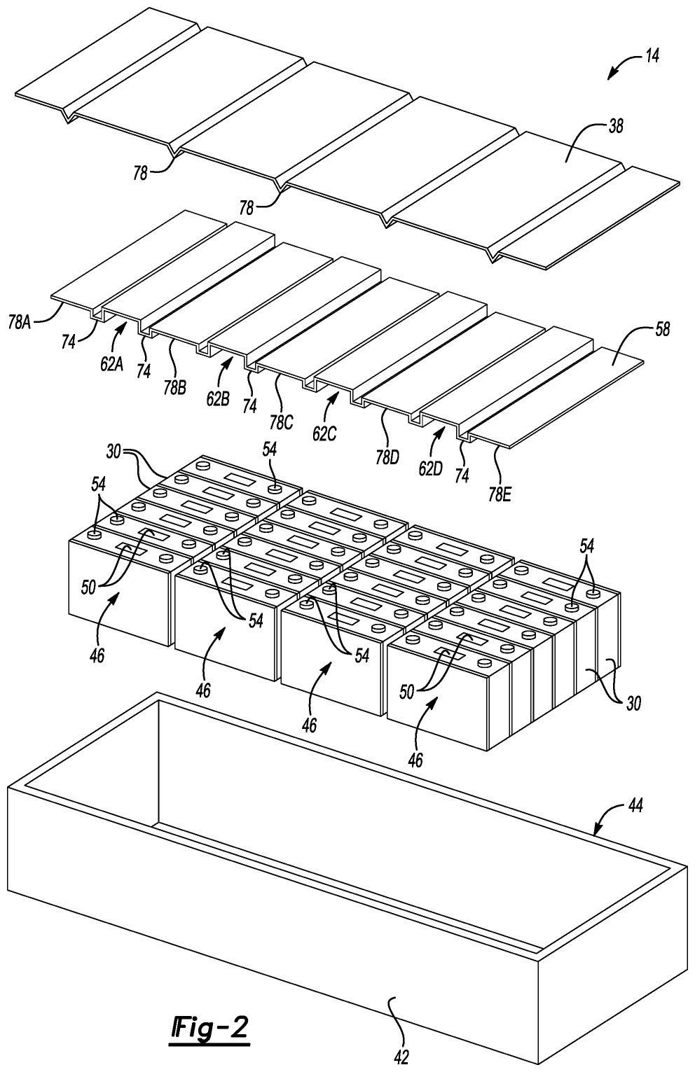

With reference now to FIGS. 2-4 and continuing reference to FIG. 1, the traction battery pack assembly 14 includes a plurality of battery cells 30 held within an enclosure assembly 34. In the exemplary embodiment, the enclosure assembly 34 includes an enclosure cover 38 and an enclosure tray 42. The enclosure cover 38 is secured to the enclosure tray 42 to provide an interior area 44 that houses the plurality of battery cells 30.

The plurality of battery cells (or simply, “cells”) 30 are for supplying electrical power to various components of the electrified vehicle 10. The battery cells 30 are stacked side-by-side relative to one another as part of a cell stack 46. The battery pack 14 includes four cell stacks 46 within the interior area 44 of the enclosure assembly 34.

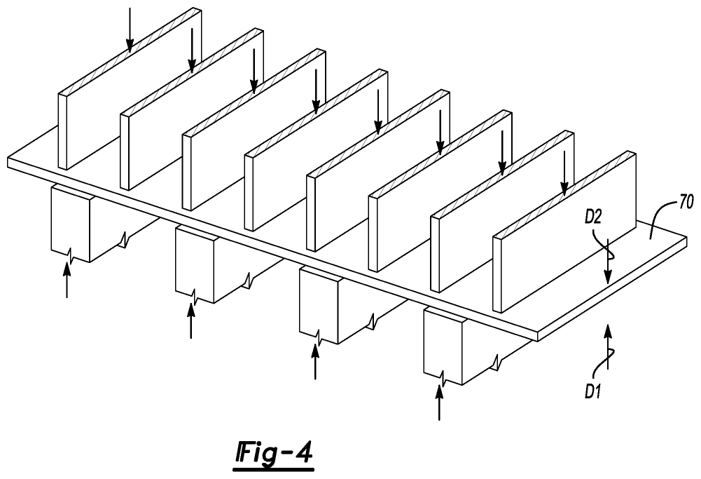

Although a specific number of battery cells 30 and cells stacks 46 are illustrated in the various figures of this disclosure, the traction battery pack assembly 14 could include any number of cells 30 and cell stacks 46. In other words, this disclosure is not limited to the specific configuration of cells 30 and cell stacks 46 shown in FIGS. 2 and 3.

In this example, the battery cells 30 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

From time to time, pressure and thermal energy within one or more of the battery cells 30 can increase. The pressure and thermal energy increase can be due to an overcharge condition, for example. The pressure and thermal energy increase can cause the associated battery cell 30 to rupture and release vent byproducts, such as gas and debris, from within the battery cell 30. The vent byproducts can be released from the associated battery cell 30 through a designated cell vent 50.

The battery cells 30 each include, in this example, the battery cell vent 50 and a pair of terminals 54. Busbars and other electrical connectors (not shown) can electrically connect the terminals 54 to other terminals 54 or other components as required.

The battery cell vent 50 is disposed between the pair of terminals 54. The battery cell vent 50 can be within a housing of the battery cell 30. The vent 50 can be a membrane that yields in response to increased pressure, or through a ruptured area of the associated battery cell 30.

From time to time, pressure and thermal energy within one or more of the battery cells 30 can increase. The pressure and thermal energy increase can be due to an overcharge condition, for example. The pressure and thermal energy increase can cause the associated battery cell 30 to rupture and release vent byproducts V, such as gas and debris, from within the battery cell 30.

The vent byproducts can be released from the associated battery cell 30 through a designated cell vent 50 within a housing of the battery cell 30. The cell vent 50 can be a membrane that yields in response to increased pressure, or through a ruptured area of the associated battery cell 30.

The battery pack 14 includes a shield 58 spanning over the cell stacks 46 within the interior area 44. In some examples, the shield 58 can be referred to as a blanket.

The shield 58 defining a first vent channel 62A with one of the cell stacks 46. The shield 58 defines a second vent channel 62B with another one of the cell stacks 46. The first vent channel 62A can receive vent byproducts from at least one battery cell 30 within the associated battery cell stack 46. The second vent channel 62B can receive vent byproducts from at least one battery cell 30 within the second battery cell stack 46.

As the example battery pack 14 includes four cell stacks 46, the example shield 58 is stamped to include four raised areas providing four vent channels 62A-62D that can each receive vent byproducts from battery cells 30 in one of the four cell stacks 46. The vent channels 62A-62D can help to compartmentalize the vent byproducts within the interior area 44 and can block convective thermal energy transfer from the vent byproducts to neighboring cell stacks 46.

The vent channels 62A-62D are open at axial ends of the respective cell stacks 46. The vent channels 62A-62D guide the vent byproducts along an axis of the cell stacks 46 to outboard sides of the interior area 44. Here, the vent byproducts can be cooled and then expelled from the enclosure assembly 34 without adding significant thermal energy to battery cells 30 that are not venting, which can help to block a thermal event cascading to other battery cells 30.

The example shield 58 is a polymer-based material, such as polypropylene. A thickness T of the shield 58 can be less than three millimeters.

The example shield 58 is formed from a sheet of material 70 that is planar. The sheet of material 70 is stamped to create raised areas that provide the first vent channel 62A and the second vent channel 62B. In other examples, the raised areas are established in other ways, such as by injection molding the shield 58 with the raised areas.

In addition to the four vent channels 62A-62D, the example shield 58 includes contact areas 74 and terminal clearance channels 78A-78E. The sheet of material 70 can be stamped to form the contact areas 74 and the terminal clearance channels 78A-78E. In an example, the sheet of material 70 is stamped in a first direction D1 to establish the four vent channels 62A-62D, and stamped in an opposite, second direction D2 to establish the contact areas 74.

The terminal clearance channels 78A-78E fit over the terminals 54. The terminal clearance channels 78A-78E are vertically raised above the battery cells 30 a first distance. The vent channels 62A-62D are vertically raised above the battery cells 30 a second distance that is greater than the first distance. The vent channels 62A-62D are thus larger than the terminal clearance channels 78A-78E. Vertical, for purposes of this disclosure, is with reference to ground and a general orientation of the vehicle 10 during operation.

The contact area 74 are, in this example, positioned between terminals 54 of one of the cell stacks 46 and the vents 50 of that one of the cell stacks 46. In some examples, the contact areas 74 are secured to the cell stacks 46. In another example, the contact areas 74 rest on the cell stacks 46.

In this example, the shield 58 is sandwiched between the enclosure cover 38 and the cell stacks 46. The enclosure cover 38 is, in this example, a metal or metal alloy. The enclosure cover 38 can be formed with a plurality of corrugations 78. The corrugations 78 have a triangular cross-sectional profiled this example. The corrugations 78 project downward toward the shield 58 and can contact the shield 58. More particularly, the corrugations 78 each contact one of the terminal clearance channels 78A-78D. Contacting the shield 58 with the corrugations 78 can help to maintain a position of the shield 58 within the interior area 44.

Features of the disclosed example shield can include insulating cell stacks from high temperature vent byproducts being expelled from other cell stacks, and additionally insulating battery terminals and busbars. Another feature is an enclosure, here an enclosure cover, having corrugations to help provide structural support. The shield can block vent-byproducts from exiting one of the battery cells and impinging directly on an enclosure wall.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
a first battery cell stack;
a second battery cell stack;
an enclosure having an interior area, the first and second battery cell stacks housed within the interior area; and
a shield spanning over the first and second battery cell stacks within the interior area, the shield defining a first channel with the first battery cell stack to receive vent byproducts from at least one battery cell within the first battery cell stack, the shield defining a second channel with the second battery cell stack to receive vent byproducts from at least one battery cell within the second battery cell stack.

2. The battery pack assembly of claim 1, wherein the shield is a polymer-based material.

3. The battery pack assembly of claim 1, wherein the shield is less than three millimeters thick.

4. The battery pack assembly of claim 1, wherein the shield is a stamped shield.

5. The battery pack assembly of claim 1, wherein the first battery cell stack include a plurality of first battery cell vents, a plurality of terminals on a first side of the plurality of first battery cell vents, and a plurality of terminals on an opposite, second side of the plurality of first battery cell vents, the shield contacting the first battery cell stack at a first location between the plurality of first battery cell vents and the plurality of terminals on the first side, the shield contacting the first battery cell stack at a second location between the plurality of first battery cell vents and the plurality of terminals on the second side.

6. The battery pack assembly of claim 5, wherein the shield is raised above the plurality of first battery cell vents more than the shield is raised of the plurality of terminals.

7. The battery pack assembly of claim 5, wherein the shield defines a third channel above the plurality of terminals on the first side, and a fourth channel above the plurality of terminals on the second side, wherein the first and second channels are larger than the third and fourth channels.

8. The battery pack assembly of claim 1, wherein the shield is sandwiched between a cover of the enclosure and the first battery cell stack.

9. The battery pack assembly of claim 1, wherein the first channel is open at an axial end of the first battery cell stack, wherein the second channel is open at an axial end of the second battery cell stack.

10. The battery pack assembly of claim 1, wherein the enclosure includes a plurality of corrugations that project toward the shield.

11. The battery pack assembly of claim 10, wherein the corrugations within the plurality of corrugations each contacts a portion of the shield providing a terminal clearance channel.

12. The battery pack assembly of claim 10, wherein a cover of the enclosure includes the plurality of corrugations.

13. The battery pack assembly of claim 10, wherein the corrugations within the plurality of corrugations each have a triangular cross-sectional profile.

14. A method of managing thermal energy within a battery pack, comprising:
positioning a shield within an interior area of an enclosure between a wall of the enclosure and a plurality of battery cells; and
using the shield to define a channel that spans over a plurality of vents of the plurality of battery cells, the channel configured to receive vent byproducts vented from the plurality of battery cells.

15. The method of claim 14, further comprising stamping the shield to establish the channel.

16. The method of claim 14, wherein the shield is a polymer-based material.

17. The method of claim 14, wherein the plurality of battery cells include a plurality of terminals on a first side of the plurality of vents, and a plurality of terminals on an opposite, second side of the plurality of vents, the shield including contact areas that contact the plurality of battery cells at a first location between the plurality of vents and the plurality of terminals on the first side, the shield including additional contact areas that contact the plurality of battery cells at a second location between the plurality of vents and the plurality of terminals on the second side.

18. The method of claim 17, further comprising stamping the shield in a first direction to provide the channels, and stamping the shield in an opposite, second direction to provide the contact areas.
